(19) United States
(12) Patent Application Publication
(10) Pub. No.: US 2009/0195521 A1
(43) Pub. Date: Aug. 6, 2009

(54) Row driver cell and row driving method for an electroluminescent display

(76) Inventors: Chien-Chung Chen, Hsinchu City (TW); Jen-Chun Peng, Zhubei City (TW); Cheng-Hung Wei, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/314,169

(22) Filed: Dec. 5, 2008

(30) Foreign Application Priority Data
Dec. 10, 2007 (TW) 096147097

(51) Int. Cl. G06F 3/038; G09G 3/30

(52) U.S. Cl. 345/204; 345/76

(57) ABSTRACT

For an electroluminescent display having an electro-luminescent element connected between a column scan line and a row scan line, a row driver cell switches the row scan line to connect to a high voltage input or a low voltage input, or to be floating, and prevents the current consumed by panel charging and discharging from flowing to the high voltage input from the row scan line.

### FIELD OF THE INVENTION

The present invention is related generally to electroluminescent (EL) displays and, more particularly, to a row driver cell and row driving method for an EL display.

### BACKGROUND OF THE INVENTION

FIGS. 1-4 illustrate the driving method for a conventional EL display 10 which includes a panel 18 and a driving apparatus for driving the panel 18. The panel 18 includes column scan lines COL1-COL720, row scan lines ROW1-ROW64, and a matrix of light-emitting diodes (LEDs) En,m, where n=1-720 and m=1-64. Each of the LEDs En,m has a parasitic capacitor Cn,m. The driving apparatus includes an emission control circuit 12, a row driver 14 and a column driver 16. According to emission data, the emission control circuit 12 provides signals for the row driver 14 and the column driver 16 to control row driver cells 142 and column driver cells 162 therein to change the voltages on the row scan lines ROW1-ROW64 and the I column scan lines COL1-COL720, respectively, and in turn to light up one or more selected LEDs En,m. FIG. 5 depicts a conventional structure of the row driver cell 142 in the EL display 10, in which a PMOS transistor 144 is connected between a voltage input VCOM and the row scan line ROWm, and an NMOS transistor 146 is connected between the row scan line ROWm and a ground terminal GND. When the row driver cell 142 is in a turned-on state, the NMOS transistor 146 is on to connect the row scan line ROWm to the ground terminal GND, and when in a reverse state, the PMOS transistor 144 is on to connect the row scan line ROWm to the voltage input VCOM. Referring to FIG. 1, the column driver cell 162 includes a driving current source 164, a voltage source 166 and a ground terminal GND. In a display state, the selected column scan line COLn is connected to the driving current source 164, in a pre-charge state, the selected column scan line COLn is connected to the voltage source 166, and in a discharge state, the selected column scan line COLn is connected to the ground terminal GND.

In the display mode, as shown in FIG. 1, the row scan line ROW1 is connected to the ground terminal GND, the other row scan lines ROW2-ROW64 are in the reverse state, the column scan lines COL1 and COL2 are connected to their driving current sources 164 respectively, and the other column scan lines COL3-COL720 are connected to their ground terminals GND, so that currents flow through the LEDs E1,1 and E2,1 and thereby light up the LEDs E1,1 and E2,1. If now to turn off the LEDs E1,1 and E2,1 and light up the LEDs E2,2 and E3,2 instead, the discharge mode has to be conducted first. Namely, as shown in FIG. 2, the row scan line ROW1 is connected to the ground terminal GND, the row scan lines ROW2-ROW64 are connected to the voltage inputs VCOM, and the column scan lines COL1-COL720 are all connected to the ground terminals GND, so as to release all charges on the parasitic capacitors Cn,m of all the LEDs En,m. Then the pre-charge mode follows thereto, as shown in FIG. 3, in which the row scan line ROW1 is connected to the voltage input VCOM, the row scan line ROW2 is connected to the ground terminal GND, and the column scan lines COL2 and COL3 are connected to the voltage source 166, so that the voltages on the column-scan lines COL2 and COL3 are charged from 0V to VCC. Finally, as shown in FIG. 4, the display mode is conduced by switching the column scan lines COL2 and COL3 to connect to their current sources 164 to light up the LEDs E2,2 and E3,2. The brightness of a lighted LED En,m depends on the current level and time duration of the current flowing therethrough.

Unfortunately, in the foregoing operations of the EL display 10, not really the whole current is used for light emission. According to the statistics obtained over tests, despite the brightness of the display, a certain amount of the current is consumed by charging and discharging the panel. For lower brightness condition, the amount of the current consumed by charging and discharging the panel can even account for up to more than a half of the total current. For example, in the discharge mode shown in FIG. 2, when the column scan line COL1 is switched to connect to the ground terminal GND, the voltage on the column scan line COL1 is immediately pulled down from VCC to 0V. In this process, the coupling effect of the parasitic capacitors will pull down the voltages on the row scan lines ROW2-ROW64. Consequently, the row scan lines ROW2-ROW64 previously at the voltage VCOM will provide considerable currents to the ground terminal GND of the row driver cells 162 through the parasitic capacitors. As such currents are not used to light up the panel, they are wasted in vain. If the column driver cells 162 are not turned off synchronously, a large current consumption can happen to the voltage source VCOM. In the charge mode shown in FIG. 3, the output of the column scan line COL2 is charged from 0V to VCC. During this process, the coupling effect of the parasitic capacitors will cause the voltages on the row scan lines ROW2-ROW64 to rise. Thus, a charging current is provided to not only the row scan line ROW1 but also the other row scan lines ROW2-ROW64. Since the charging currents going to the row scan lines ROW2-ROW64 drain away through the voltage source VCOM but not used for light emission, they are also wasted and therefore there are sixty-four capacitors observed from the column scan line COL2.

Though many arts have been suggested for reducing power consumption of EL displays, such as U.S. Pat. Nos. 5,594,463, 5,844,368, 6,104,363, 6,191,535, 6,310,589, 6,376,994, 6,473,064 and 6,501,226, none of them provides a solution to improve the current consumption caused by panel charging and discharging. Consequently, the precharge mode is still an indispensable process for driving EL displays.

### SUMMARY OF THE INVENTION

An objective of the present invention is to provide a row driver cell and row driving method for an EL display, to reduce current consumption caused by panel charging and discharging.

Another objective of the present invention is to provide a row driver cell and row driving method for an EL display, to eliminate the need of a precharge process for driving the EL display.

According to the present invention, for an EL display having an electroluminescent element connected between a column scan line and a row scan line, a row driver cell has a first switch connected between the row scan line and a high voltage input, a second switch connected between the row scan line and a low voltage input, and a reverse device serially connected to the first switch to prevent reverse currents from the row scan line to the high voltage input.

Alternatively, a row driver cell according to the present invention has a first MOS transistor connected between the row scan line and the high voltage input, a second MOS transistor connected between the row scan line and the low voltage input, and a voltage source applying a voltage to the substrate of the first MOS transistor to prevent the parasitic diode in the structure of the first MOS transistor from being turned on.

According to the present invention, in a row driving method for an EL display having a panel including column scan lines and row scan lines, a selected one of the row scan lines is switched to a turned-on state and is further switched to a reverse state after the turned-on state is finished, and after the selected row scan line is switched to the reverse state for a time period, it is switched to a floating state and kept in the floating state until it is switched to the turned-on state again.

In an alternative row driving method according to the present invention, when a selected one of the row scan lines is switched to a turned-on state; the other row scan lines are switched to a floating state, and during the selected row scan line is in the turned-on state, if the column scan lines are switched to a-discharge state, the other row scan lines are switched to a reverse state.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a diagram to show a conventional EL display in a display mode;

FIG. 2 is a diagram to show the EL display of FIG. 1 in a discharge mode;

FIG. 3 is a diagram to show the EL display of FIG. 1 in a precharge mode;

FIG. 4 is a diagram to show the EL display of FIG. 1 in the display mode;

FIG. 5 is a circuit diagram of a conventional row driver cell in the EL display of FIG. 1;

FIG. 6 is a circuit diagram of a row driver cell according to the present invention;

FIG. 7 depicts an embodiment for the reverse device in the row driver cell of FIG. 6;

FIG. 8 is a circuit diagram of another row driver cell according to the present invention;

FIG. 9 is a circuit diagram of an EL display according to the present invention;

FIG. 10 is a timing diagram of a driving method for the EL display of FIG. 9;

FIG. 11 is a diagram to show the EL display of FIG. 9 in a discharge mode when using the driving method of FIG. 10;

FIG. 12 is a diagram to show the EL display of FIG. 9 in a precharge mode when using the driving method of FIG. 10;

FIG. 13 is a diagram to show the EL display of FIG. 9 in a display mode when using the driving method of FIG. 10;

FIG. 14 is a timing diagram of another driving method for the EL display of FIG. 9;

FIG. 15 is a diagram to show the EL display of FIG. 9 in a discharge mode when using the driving method of FIG. 14;

FIG. 16 is a diagram to show the EL display of FIG. 9 in a precharge mode when using the driving method of FIG. 14;

FIG. 17 is a diagram to show the EL display of FIG. 9 in a display mode when using the driving method of FIG. 14;

FIG. 18 is a timing diagram of a conventional driving method for the EL display of FIG. 1;

FIG. 19 is a timing diagram in a simulation when using the conventional row driver cell of FIG. 5 and the conventional driving method of FIG. 18; and

FIG. 20 is a timing diagram in a simulation when using the row driver cell according to the present invention and the conventional driving method of FIG. 18.

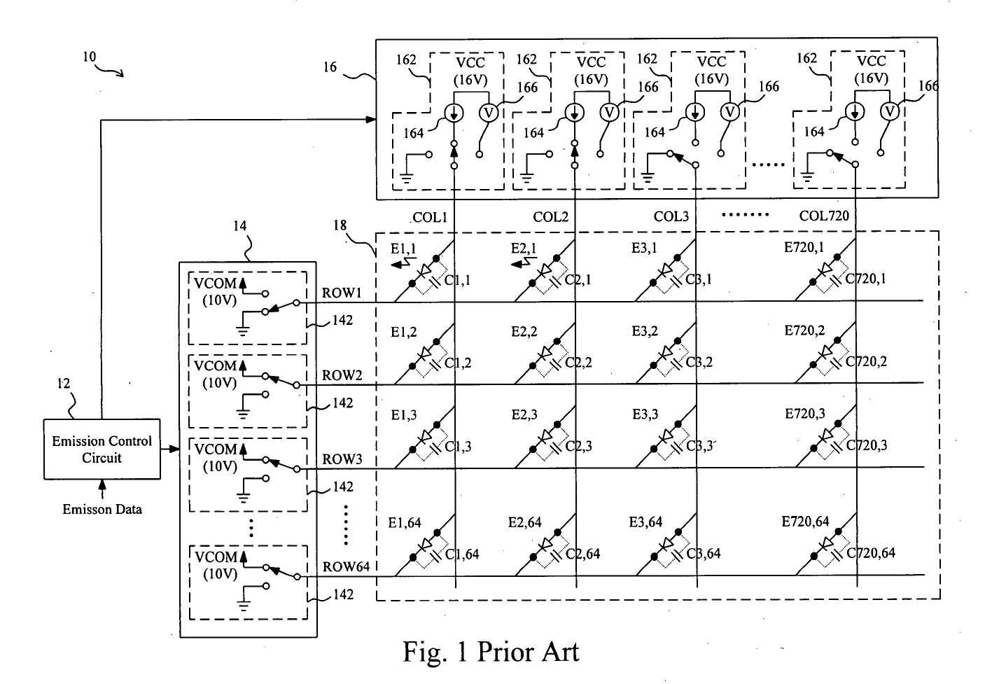

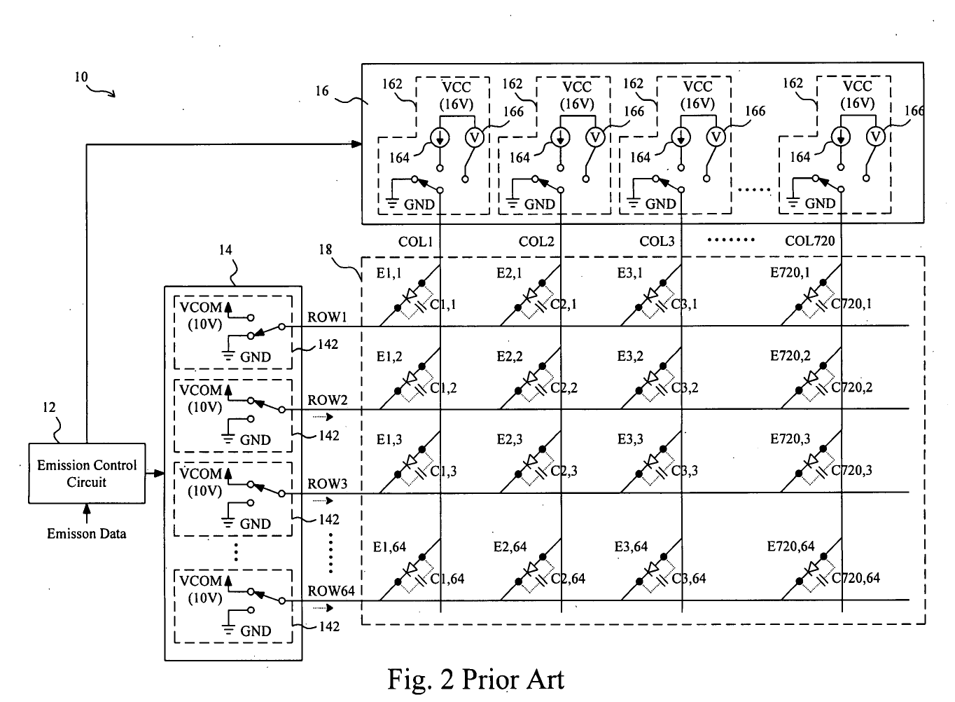

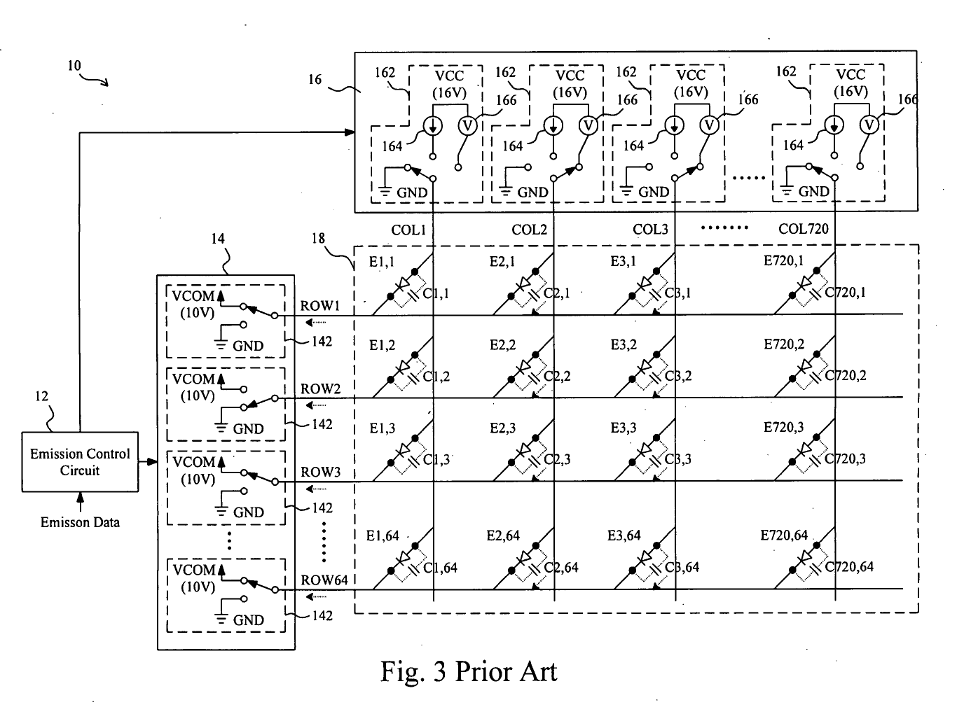

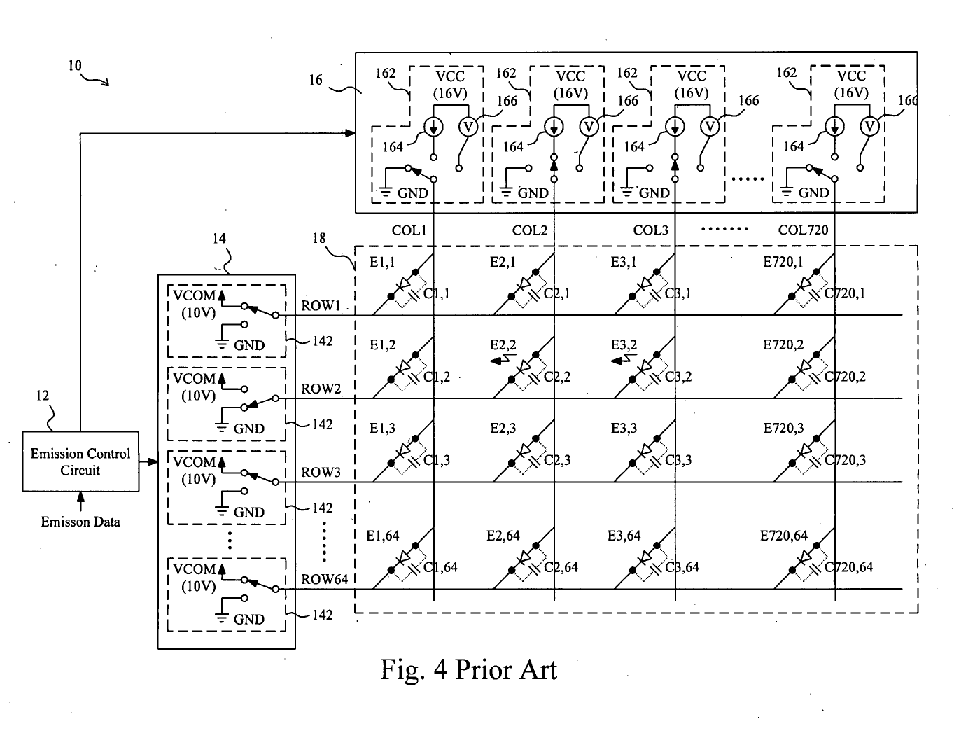

### DETAIL DESCRIPTION OF THE INVENTION

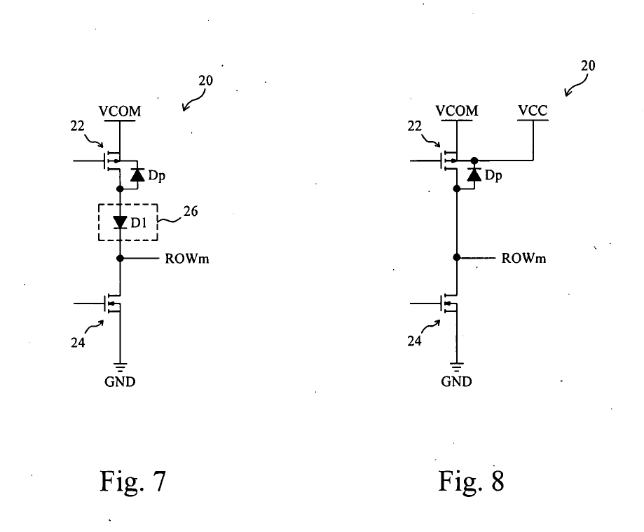

FIG. 6 shows a row driver cell 20 according to the present invention, which has a floating state in addition to a turned-on state and a reverse state. In the floating state, a PMOS transistor 22 and an NMOS transistor 24 are both turned off. In the row driver cell 20, the PMOS transistor 22 functions for connecting a row scan line ROWm to a voltage input VCOM, the NMOS transistor 24 functions for connecting the row scan line ROWm to a ground terminal GND, and a reverse device 26 is connected between the PMOS transistor 22 and the row scan line ROWm. In a precharge mode, though the transistors 22 and 24 are both turned off, current can still flow to the voltage input VCOM through the parasitic diode DP in the structure of the PMOS transistor 22. Therefore, the reverse device 26 is added to prevent reverse currents from the row scan line ROWm to the voltage input VCOM. However, the reverse device 26 does not influence the normal states of the row scan line ROWm (connected to the ground terminal GND or the voltage input VCOM). FIG. 7 provides an embodiment for the reverse device 26, which includes a diode D1. In other embodiments, a bipolar junction transistor (BJT) or a MOS transistor configured as a diode may be used instead. FIG. 8 shows another row driver cell 20 according to the present invention, which includes a PMOS transistor 22 and an NMOS transistor 24 configured as that of FIG. 6, and a voltage source VCC applying a voltage to the substrate of the PMOS transistor 22. The voltage VCC is the highest one in the driving apparatus and prevents the parasitic diode Dp in the structure of the PMOS transistor 22 from being turned on, thereby preventing reverse current from the row scan line ROWm to the voltage input VCOM.

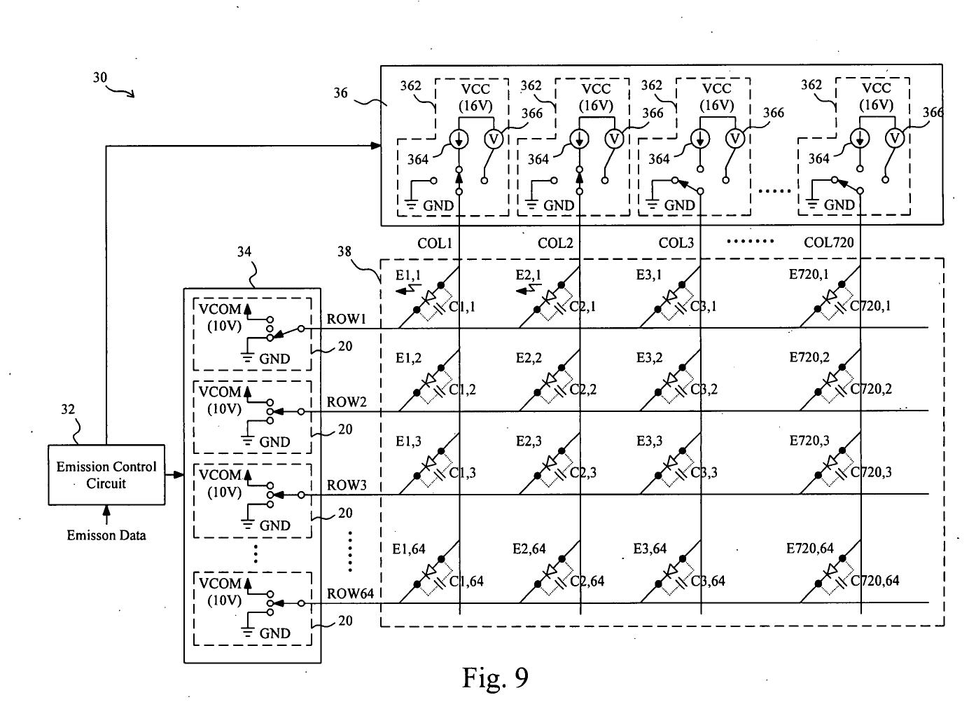

FIG. 9 shows an EL display 30 according to the present invention, which includes a panel 38 and a driving apparatus for driving the panel 38. The panel 38 includes column scan lines COL1-COL720, row scan lines ROW1-ROW64, and a matrix of LEDs En,m, where n=1-720 and m=1-64. Each of the LEDs En,m, has a parasitic capacitor Cn,m. The driving apparatus includes an emission control circuit 32, a row driver 34 and a column driver 36. According to emission data, the emission control circuit 32 provides signals for the row driver 34 and the column driver 36 to control row driver cells 20 and column driver cells 362 therein to change the voltages on the row scan lines ROW1-ROW64 and the column scan lines COL1-COL720 to light up the selected LEDs En,m. The row driver cells 20 can switch the row scan lines ROW1-ROW64 to connect to the ground terminals GND or the voltage inputs VCOM, or to be floating, and can prevent currents flowing from the row scan lines ROW1-ROW64 to the voltage inputs VCOM, thereby remaining charges accumulated on the scan lines. The column driver cells 362 can switch the column scan lines COL1-COL720 to connect to the ground terminals GND, current sources 364 or voltage sources 366.

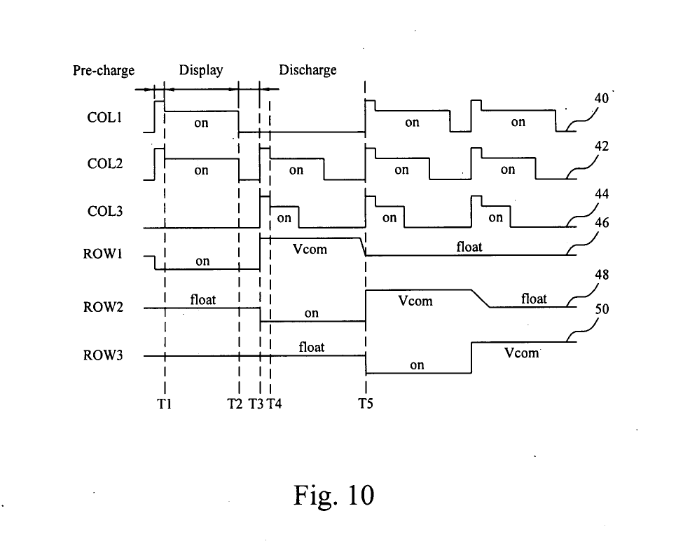

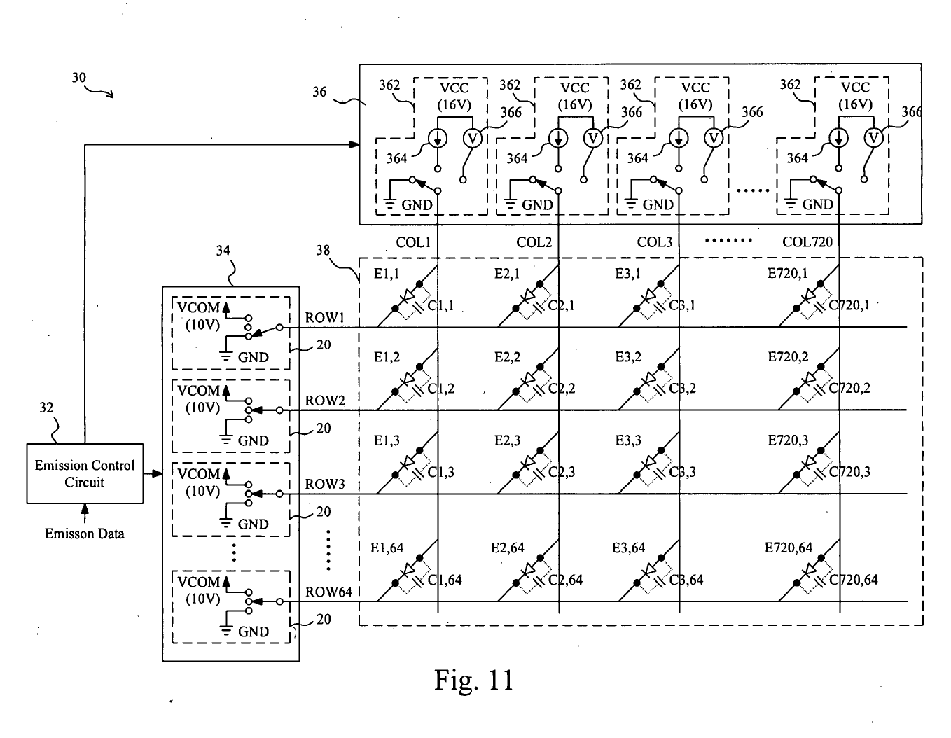

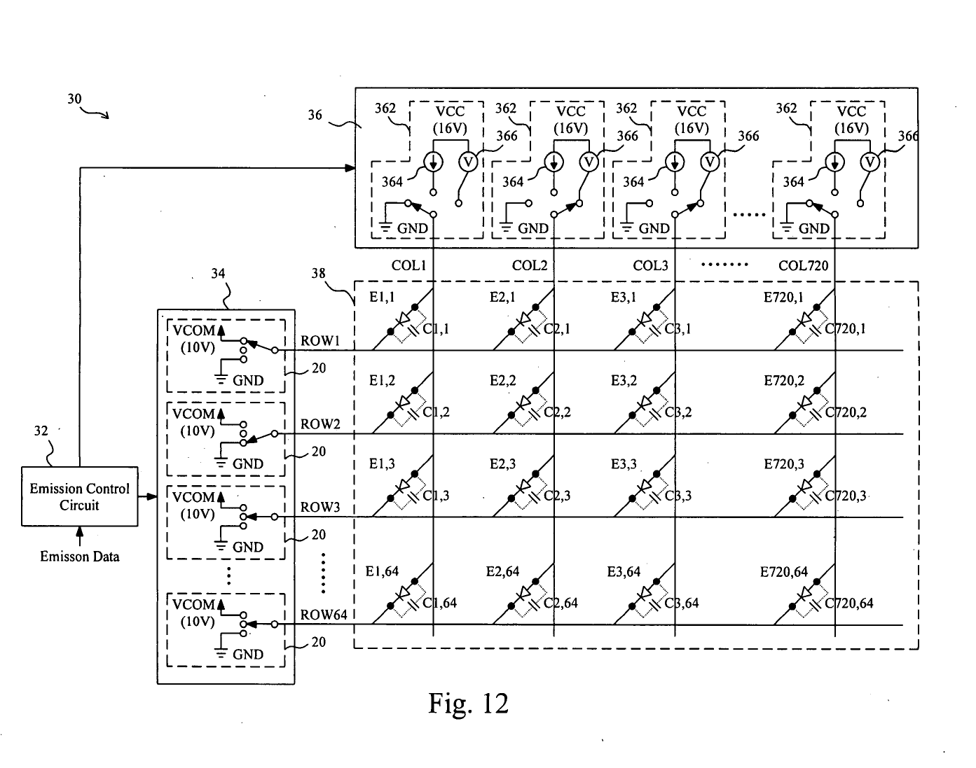

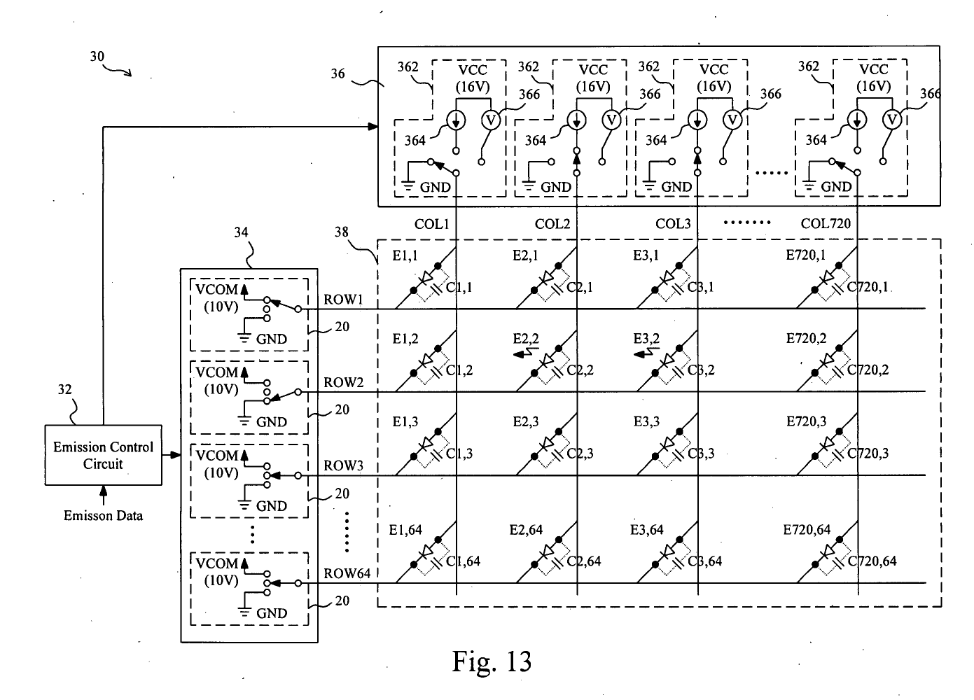

FIG. 10 is a timing diagram to show an operating method of the row driver cells 20, in which waveform 40 represents the voltage on the column scan line COL1, waveform 42 represents the voltage on the column scan line COL2, waveform 44 represents the voltage on the column scan line COL3, waveform 46 represents the voltage on the row scan line ROW1, waveform 48 represents the voltage on the row scan line ROW2, and waveform 50 represents the voltage on the row scan line ROW3. FIGS. 9, 11, 12 and 13 are provided for illustrating the driving method of FIG. 10. At time T1, as shown in FIG. 9, the row scan line ROW1 is in the turned-on state, and the column scan lines COL1 as well as COL2 are connected to the driving current sources 364, so that the LEDs E1,1 and E2,1 are lighted up. If the LEDs E2,2 and E3,2 are to be lighted next, at time T2, as shown in FIG. 11, the column scan lines COL1 and COL2 are switched to connect to the ground terminals GND to be discharged. During discharging, since the other row scan lines ROW2-ROW64 are in the floating state, no current flows from the voltage inputs VCOM to the column driver cells 362, i.e., no current is wasted. At time T3, as shown in FIG. 12, the row scan line ROW1 is switched to the reverse state to pull high the voltage on the row scan line ROW1 to VCOM, and the row scan line ROW2 is switched to the turned-on state. Meanwhile, the column scan lines COL2 and COL3 are switched to connect to the voltage sources 366 to precharge the parasitic capacitors C2,2 and C3,2. During precharging, since the row driver cell 20 prevents reverse current from the row scan line ROWm to the voltage input VCOM, no current is wasted. Thus, the charges will accumulate at the output of the row scan line ROWm and will charge back to the parasitic capacitor Cn,m when the column driver cell 362 enters the discharge mode. At time T4, as shown in FIG. 13, the column scan lines COL2 and COL3 are switched to connect to the driving current sources 364 to light up the LEDs E2,2 and E3,2. At time T5, the row scan line ROW1 is switched to and maintained in the floating state until the row scan line ROW1 is turned on again. Since no current flows to the voltage input VCOM, there is only one parasitic capacitor observed from each column driver cell 362. Therefore, even without the present of the voltage source 366 for providing a precharging current, the current source 364 is capable of pulling high the voltage on the output of the column driver cell 362 to an operational voltage in a very short time period. In other words, the precharge process can be left out.

In the aforementioned driving method, the reason for the row scan line ROW1 to be switched to the reverse state after the turned-on state is finished is that after the turned-on state is finished, the voltage on the row scan line ROW1 is 0, thus later in the precharge mode, the voltage on the row scan line ROW1 can be only pulled high to VCC and therefore, when the row scan line ROW2 is turned on, the voltage on the row scan line ROW1 can only vary between 0V and VCC. If the voltage on the row scan line ROW1 is previously pulled high to VCOM, when the row scan line ROW2 is later turned on, the voltage on the row scan line ROW1 can vary between VCOM+VCC and VCOM. The more charges accumulated on the row scan line ROW1, the more charges can be supplemented in the discharge mode. When entering the discharge mode at time T2 of FIG. 10, since the row scan lines ROW2-ROWn are in the floating state, if the voltage on the column scan line COL1 is pulled down to 0V, the voltages on the column scan lines COL2-COL720 are also pulled down due to the coupling effect. If more charges are on the row scan lines, more charges can be re-charged so that the voltage difference of the column scan lines COL2-COL720 caused by the coupling effect can be reduced. That is to say, the influence the coupling effect causes to the column scan lines COL2-COL720 can be reduced.

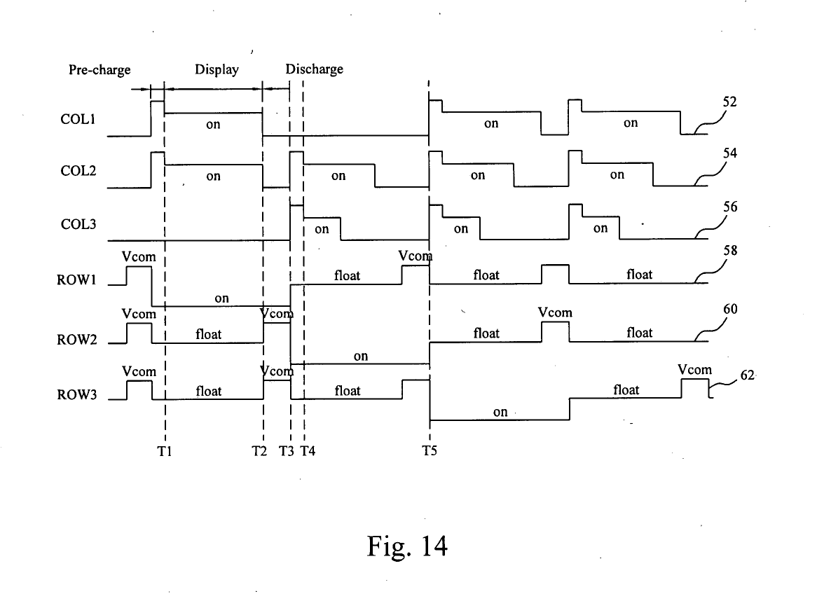

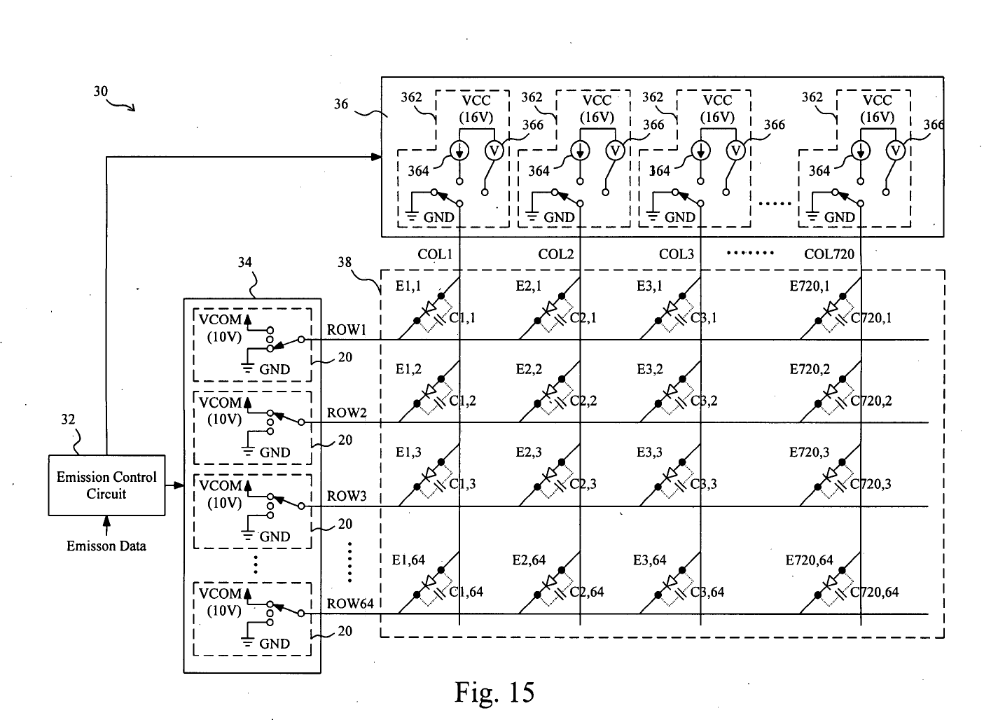

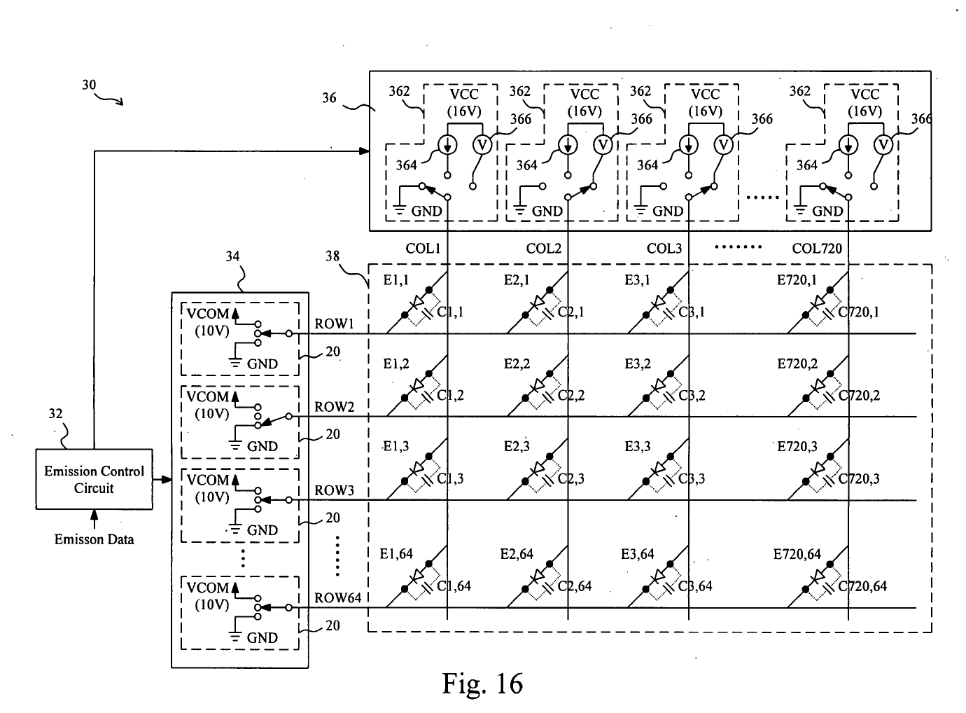

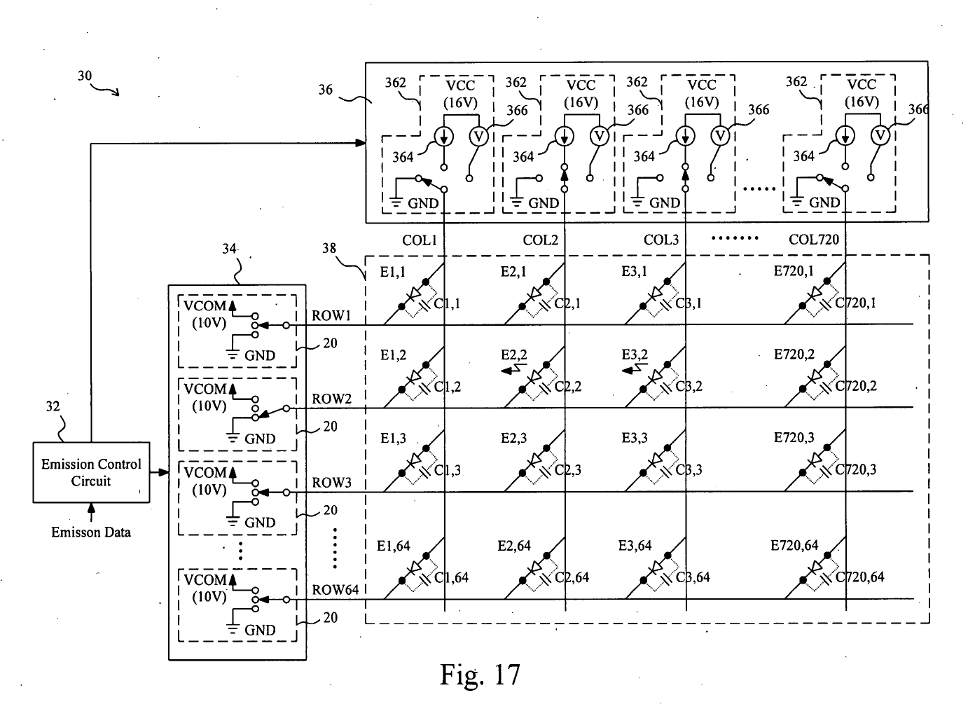

FIG. 14 is a timing diagram to show another operating method of the row driver cells 20, in which waveform 52 represents the voltage on the column scan line COL1, waveform 54 represents the voltage on the column scan line COL2, waveform 56 represents the voltage on the column scan line COL3, waveform 58 represents the voltage on the row scan line ROW 1, waveform 60 represents the voltage on the row scan line ROW2, and waveform 62 represents the voltage on the row scan line ROW3. FIGS. 9, 15, 16 and 17 are provided for illustrating the driving method of FIG. 14. At time T1, as shown in FIG. 9, the row scan line ROW1 is in the turned-on state, the row scan lines ROW2-ROW64 are in the floating state, the column scan lines COL1 and COL2 are connected to the driving current sources 364 to light up the LEDs E1,1 and E2,1, and the column scan lines COL3-COL720 are connected to the ground terminals GND. At time T2, as shown in FIG. 15, the column scan lines COL1 and COL2 are switched to connect to the ground terminals GND to discharge the parasitic capacitors C1,1 and C2,1, and except the row scan line ROW1 that is in the turned-on state, all the other row scan lines ROW2-ROW64 are switched to the reverse state to pull high the voltages on the row scan lines ROW2-ROW64 to VCOM. At time T3, as shown in FIG. 16, the row scan line ROW2 is switched to the turned-on state, the row scan lines ROW1 and ROW3-ROW64 are switched to the floating state, and the column scan lines COL2 and COL3 are switched to connect to the voltage sources 366 to be precharged. During precharging, since the row driver cell 20 prevents reverse current from the row scan line ROWm to the voltage input VCOM, no current is wasted. Thus, the charges accumulated at the output of the row scan line ROWm can be charged back to the parasitic capacitor Cn,m when the column driver cell 362 enters the discharge mode. At time T4, as shown in FIG. 17, the column scan lines COL2 and COL3 are switched to connect to the driving current sources 364 to light up the LEDs E2,2 and E3,2. Since no current flows to the voltage input VCOM, there is only one parasitic capacitor observed from each column driver cell 362. Therefore, even without the present of the voltage source 366 for providing a precharging current, the current source 364 is capable of pulling high the voltage on the output of the column driver cell 362 to an operational voltage in a very short time period. In other words, the precharge process can be left out.

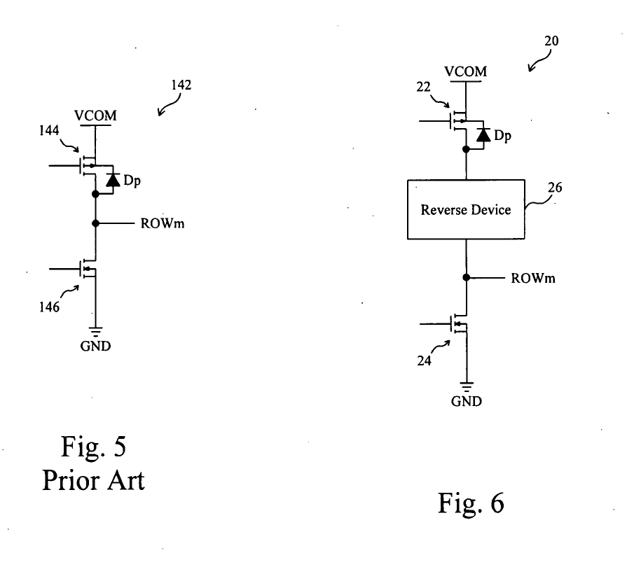

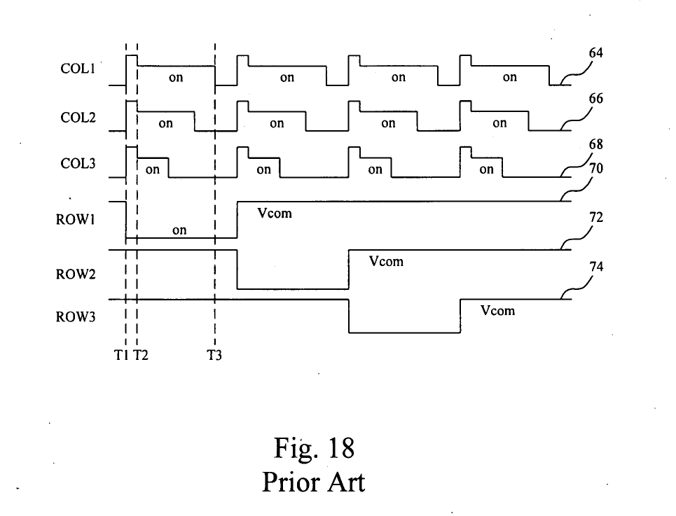

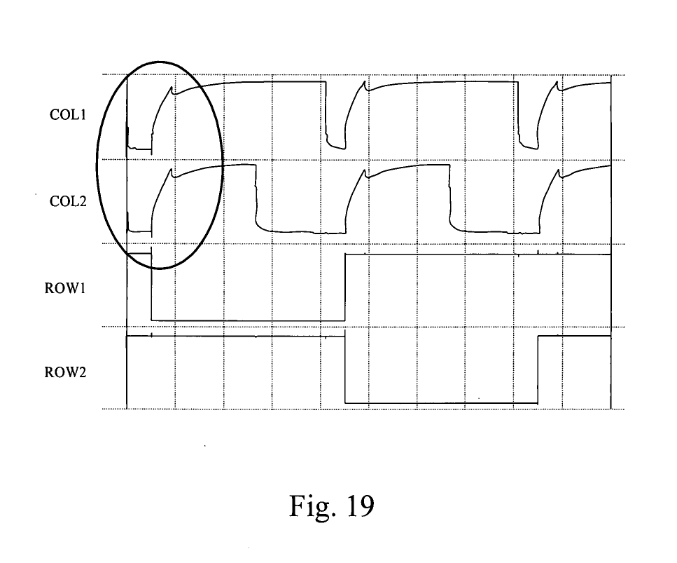

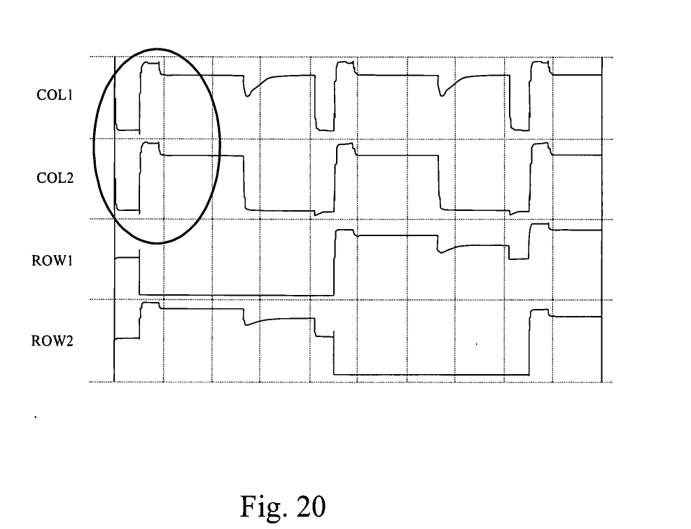

Besides, by using the row driver cell 20 with the conventional operating method, power consumption can be also efficiently improved. FIG. 18 is a timing diagram to show the conventional driving method, in which waveform 64 represents the voltage on the column scan line COL1, waveform 66 represents the voltage on the column scan line COL2, waveform 68 represents the voltage on the column scan line COL3, waveform 70 represents the voltage on the row scan line ROW 1, waveform 72 represents the voltage on the row scan line ROW2, and waveform 74 represents the voltage on the row scan line ROW3. At time T1, the row scan line ROW1 is switched to connect to the ground terminal GND to enter the turned-on state, the other row scan lines ROW2-ROW3 are connected to the voltage inputs VCOM, and the column scan lines COL1-COL3 are switched to connect to the voltage sources to be precharged. Since the row driver cells 20 prevent reverse currents from the row scan lines ROW2 and ROW3 to the voltage input VCOM, no current drains away through the voltage source VCOM to cause wasted current. FIG. 19 is a timing diagram in a simulation when using the conventional row driver cells 142 of FIG. 5 and the conventional driving method of FIG. 18. FIG. 20 is a timing diagram in a simulation when using the row driver cell 20 of FIG. 6 and the conventional driving method of FIG. 18. Through FIGS. 19 and 20, it is obvious that the EL display using the row driver cell 20 has the column scan line COL1 reaching the desired voltage more quickly during the precharging process. Since there is no current flowing from the row scan line to the voltage input VCOM, only one parasitic capacitor is observed from each of the column scan lines. Therefore, even without the present of the voltage source for providing a precharging current, the current source is capable of pulling high the voltage on the column scan line in a very short time period. In other words, the precharge process can be left out.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A row driver cell for an electroluminescent display having an electroluminescent element connected between a column scan line and a row scan line, comprising:
a first switch connected between the row scan line and a high voltage input;
a second switch connected between the row scan line and a low voltage input; and
a reverse device serially connected to the first switch to prevent reverse currents from the row scan line to the high voltage input.

2. The row driver cell of claim 1, wherein the row scan line is floating when both the first and second switches are off.

3. The row driver cell of claim 1, wherein the reverse device comprises a diode.

4. The row driver cell of claim 1, wherein the reverse device comprises a bipolar junction transistor configured as a diode.

5. The row driver cell of claim 1, wherein, the reverse device comprises a MOS transistor configured as a diode.

6. A row driver cell for an electroluminescent display having an electroluminescent element connected between a column scan line and a row scan line, comprising:
a first MOS transistor being controlled to connect the row scan line to a high voltage input;
a second MOS transistor being controlled to connect the row scan line to a low voltage input; and
a voltage source applying a voltage to the substrate of the first MOS transistor to prevent the parasitic diode in the structure of the first MOS transistor from being turned on.

7. The row driver cell of claim 6, wherein the row scan line is floating when both the first and second MOS transistors are off.

8. A row driving method for an electroluminescent display including a panel having a plurality of column scan lines and a plurality of row scan lines, comprising:
switching a selected one of the plurality of row scan lines to a turned-on state;
switching the selected row scan line to a reverse state after its turned-on state is finished; and
after the selected row scan line is switched to the reverse state for a time period, switching it to a floating state and keeping it in the floating state until it is switched to the turned-on state again.

9. A row driving method for an electroluminescent display including a panel having a plurality of column scan lines and a plurality of row scan lines, comprising:
when a selected one of the plurality of row scan lines is switched to a turned-on state, switching the other ones of the plurality of row scan lines to a floating state; and
during the selected row scan line is in the turned-on state, if the plurality of column scan lines are switched to a discharge state, switching the other ones of the plurality of row scan lines to a reverse state.
